(19) United States
(12) Patent Application Publication
(10) Pub. No.: US 2026/0248593 A1
(43) Pub. Date: Aug. 27, 2026

(54) CLEAR ALIGNER GEOMETRIC REINFORCEMENT

(71) Applicant: Aliwell SAPI de CV, San Pedro Garza Garcia (MX)

(72) Inventors: Roberto Carrillo Fuentevlla, San Pedro Garza Garcia (MX); Roberto Carrillo Gonzalez, San Pedro Garza Garcia (MX)

(21) Appl. No.: 19/550,053

(22) Filed: Feb. 25, 2026

Related U.S. Application Data
(60) Provisional application No. 63/763,103, filed on Feb. 25, 2025.

(51) Int. Cl. A61C 7/08; A61C 7/00; B29C 51/00

(52) U.S. Cl. CPC A61C 7/08; A61C 7/002; B29C 51/00

(57) ABSTRACT

A clear aligner including a main body and a geometric reinforcement. The main body can be formed of a clear plastic and formed from a digital model of a dental arch. The geometric reinforcement can be integrated into the main body and configured to deflect or bend a portion of the main body to generate a differential force applied to a tooth.

### CROSS-REFERENCE TO RELATED APPLICATION AND PRIORITY CLAIM

This application claims priority under 35 U.S.C. § 119(e) to U.S. Provisional Patent Application No. 63/763,103 filed on February 25, 2025, which is hereby incorporated by reference in its entirety.

### TECHNICAL FIELD

This disclosure relates generally to orthodontic devices and processes. More specifically, this disclosure relates to a clear aligner geometric reinforcement.

### BACKGROUND

Clear aligners have become a widely adopted solution in orthodontics for correcting malocclusions and repositioning teeth. These devices offer an aesthetic and removable alternative to traditional braces, relying on controlled forces to guide dental movement over time. The design and material properties of clear aligners influence their mechanical behavior, with varying thicknesses and polymer compositions affecting their flexibility, durability, and patient comfort. While thicker aligners provide greater resistance to deformation, they can be uncomfortable and visually obtrusive, making material optimization a critical consideration in aligner design.

### SUMMARY

This disclosure provides a clear aligner geometric reinforcement.

In a first embodiment, a clear aligner including a main body and a geometric reinforcement. The main body can be formed of a clear plastic and formed from a digital model of a dental arch. The geometric reinforcement can be integrated into the main body and configured to deflect or bend a portion of the main body to generate a differential force applied to a tooth.

In a second embodiment, a method can include designing a digital model of a dental arch. The method can also include printing a 3D mold using the digital model. The method additionally can include thermoforming a main body formed of clear plastic with a geometric reinforcement integrated into the main body using the 3D mold, wherein the geometric reinforcement generates a differential force applied to a tooth.

In a third embodiment, a method can include designing a digital model of a dental arch. The method can also include printing a main body formed of clear plastic with a geometric reinforcement integrated into the main body using the digital model, wherein the geometric reinforcement generates a differential force applied to a tooth.

In one or more of the above embodiments, the main body can include an extension, and the geometric reinforcement can be integrated at least partially in the extension.

In one or more of the above embodiments, the digital model can include a curved pathway along a gingival margin, and the geometric reinforcement is integrated along the curved pathway.

In one or more of the above embodiments, the geometric reinforcement can include multiple geometric reinforcements, and each of the multiple geometric reinforcements is integrated corresponding to the tooth in the digital model of the dental arch.

In one or more of the above embodiments, the clear aligner can further include a connector configured to connect to adjacent geometric reinforcements of the multiple geometric reinforcements.

In one or more of the above embodiments, the geometric reinforcement can have a shape that is curved and an orientation that corresponds to a natural curvature of the tooth, and the shape of the geometric reinforcement is configured to provide the differential force to the tooth.

In one or more of the above embodiments, the geometric reinforcement can include multiple geometric reinforcements; and at least two of the multiple geometric reinforcements can be curved and oriented to correspond to different natural curvatures of the tooth.

Other technical features may be readily apparent to one skilled in the art from the following FIGS., descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate an example clear aligner having an integrated geometric reinforcement structure in accordance with this disclosure;

FIGS. 2A and 2B illustrate an example model for an integrated geometric reinforcement structure within a 3D software environment in accordance with this disclosure;

FIGS. 3A and 3B illustrate an example model for an integrated geometric reinforcement structure applied to a group of teeth in accordance with this disclosure;

FIG. 4 illustrates an example process for manufacturing clear aligner having an integrated geometric reinforcement structure in accordance with this disclosure; and

FIGS. 5A, 5B, and 5C illustrate example stages for manufacturing clear aligner having an integrated geometric reinforcement structure in accordance with this disclosure.

### DETAILED DESCRIPTION

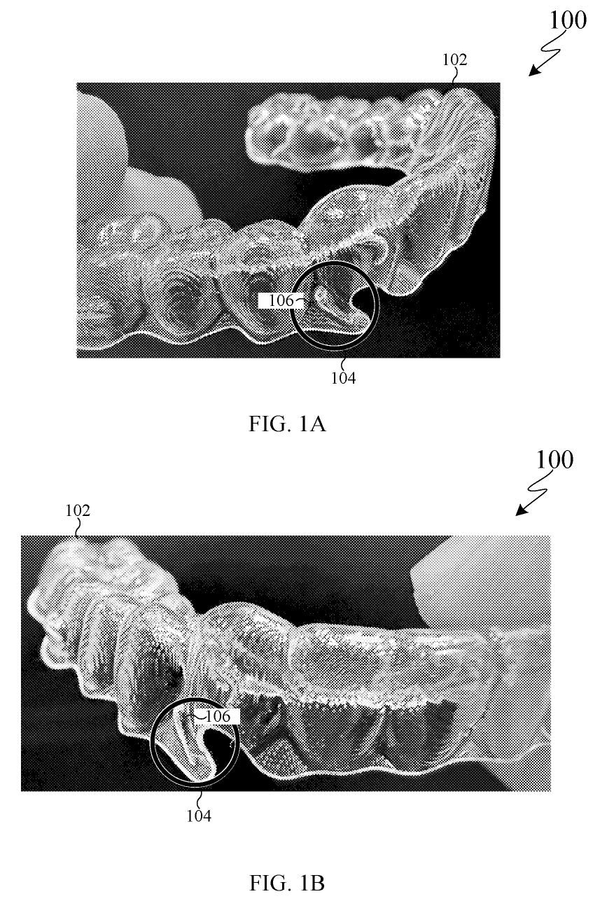

FIGS. 1 through 5C, described below, and the various embodiments used to describe the principles of the present disclosure are by way of illustration only and should not be construed in any way to limit the scope of the disclosure. Those skilled in the art will understand that the principles of the present disclosure may be implemented in any type of suitably arranged device or system.

During treatment, aligners experience localized stress concentrations, particularly in areas subjected to accessory forces such as elastics, chains, or intermaxillary anchorage. These forces can exceed the aligner’s elastic limit, leading to permanent deformation that alters its fit and reduces its effectiveness. In some cases, specific extensions, flaps, or cutouts designed for force application lose their intended function due to material bending or flexing. Such deformations compromise force transmission, leading to suboptimal treatment outcomes and discomfort for the patient.

Various reinforcement strategies have been explored, including material layering and alternative polymer formulations. However, these approaches often introduce trade-offs between stiffness, flexibility, and esthetics. An effective solution should maintain the aligner’s shape, prevent unintended flexing, and ensure precise force application, thereby improving treatment predictability and patient experience.

Illustrative embodiments provide clear aligners having an integrated geometric reinforcement structure to enhance resistance to deformation while maintaining a thin, comfortable profile. The reinforcement is designed as a geometric skeleton that can be directly integrated into the 3D model or printed alongside the aligner, providing targeted structural support without compromising aesthetics or comfort. The reinforcement strengthens specific areas of the aligners - such as extensions, flaps, or cutouts used for elastics and auxiliary forces - allowing the aligner to retain its intended shape and effectively transmits corrective forces.

The reinforcement can be separated into discrete structures or connected through a unifying element, depending on the desired mechanical response. This method allows for greater design flexibility by enabling single or multiple geometric reinforcement elements to be placed strategically based on the aligner’s mechanical requirements. This approach enables more precise force application, ensuring that intended movements occur as planned while reducing discomfort caused by misaligned or deformed extensions.

Unlike conventional methods that rely on increasing material thickness or modifying polymer composition to improve mechanical properties, this approach incorporates a predefined structural reinforcement within the aligner itself. The reinforcement structure is embedded during the forming process, while in directly printed aligners, the reinforcement is incorporated into the digital design and materialized in a single manufacturing step. The reinforcement can be either hollow or filled with the same or different materials, allowing for further customization of structural properties based on the specific needs of the treatment.

One or more embodiments are directed to clear aligners having an integrated geometric reinforcement structure to enhance resistance to deformation while maintaining a thin, comfortable profile. The reinforcement is designed as a geometric skeleton that can be directly integrated into the 3D model or printed alongside the aligner, providing targeted structural support without compromising aesthetics or comfort. The reinforcement strengthens specific areas of the aligners - such as extensions, flaps, or cutouts used for elastics and auxiliary forces - allowing the aligner to retain its intended shape and effectively transmits corrective forces.

The reinforcement can be separated into discrete structures or connected through a unifying element, depending on the desired mechanical response. This method allows for greater design flexibility by enabling single or multiple geometric reinforcement elements to be placed strategically based on the aligner’s mechanical requirements. This approach enables more precise force application, ensuring that intended movements occur as planned while reducing discomfort caused by misaligned or deformed extensions.

Unlike conventional methods that rely on increasing material thickness or modifying polymer composition to improve mechanical properties, this approach incorporates a predefined structural reinforcement within the aligner itself. The reinforcement structure is embedded during the forming process, while in directly printed aligners, the reinforcement is incorporated into the digital design and materialized in a single manufacturing step. The reinforcement can be either hollow or filled with the same or different materials, allowing for further customization of structural properties based on the specific needs of the treatment.

FIGS. 1A and 1B illustrate an example clear aligner 100 having an integrated geometric reinforcement structure in accordance with this disclosure. As shown in FIGS. 1A and 1B, the aligner 100 conforms to the dental arch and includes a main body 102 with a contoured surface with defined impressions corresponding to individual teeth. A specific section of the aligner 100, identified by a circle, contains a reinforced extension 104. This extension 104 protrudes from the main body 102 of the aligner 100 and is structured to interface with an external force application mechanism such as elastics or auxiliary orthodontic devices.

The geometric reinforcement 106 is embedded within the extension 104, forming a distinct shape that enhances its mechanical stability. The geometric reinforcement 106 is positioned along the contour of the extension 104, providing additional resistance to deformation when subjected to tensile or compressive forces. For example, the geometric reinforcement 106 changes the deflection or bending properties of a specific area of the main body 102. This deflection or bending of the specific area of the main body 102 results in a differential force applied to a tooth corresponding to the geometric reinforcement 106. The material of the aligner 100 remains continuous around the geometric reinforcement 106, integrating the geometric reinforcement 106 into the overall structure. The geometric reinforcement 106 does not interfere with the primary function of the aligner 100 but serves to maintain the structural integrity of the extension 104 under applied loads. The alignment of the geometric reinforcement 106 within the extension 104 is configured to provide localized support while maintaining the flexibility necessary for insertion and removal of the aligner 100.

Although FIGS. 1A and 1B illustrate an example clear aligner 100 having an integrated geometric reinforcement 106, various changes may be made to FIGS. 1A and 1B. For example, the number and placement of various components of the aligner 100 can vary as needed or desired. In addition, the aligner 100 may be used in any other suitable orthodontic manufacturing process and is not limited to the specific processes described above.

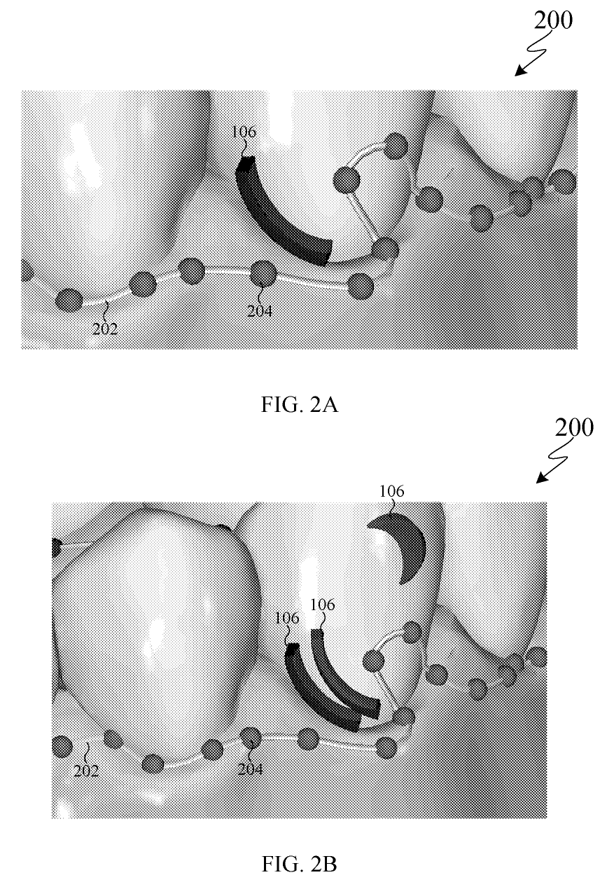

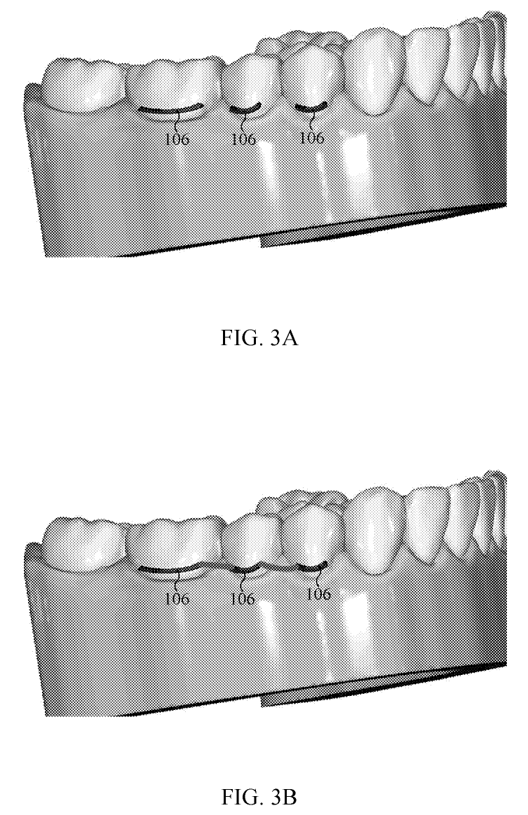

FIGS. 2A and 2B illustrate an example digital model 200 for an integrated geometric reinforcement 106 within a 3D software environment in accordance with this disclosure. As shown in FIGS. 2A and 2b, a digital model 200 for an integrated geometric reinforcement 106 within a 3D software environment can include a section of the dental arch, including teeth, gingival tissue, and a digital model 200 of a geometric reinforcement 106 applied to the aligner 100. A series of nodes 204, represented as blue and red dots, define the contour of the aligner 100 along the gingival margin. These nodes 204 are interconnected by a curved pathway 202, indicating the designed placement of the geometric reinforcement 106 along the structure of the aligner 100.

The geometric reinforcement 106 consists of curved elements positioned adjacent to the teeth. These elements are designed to enhance the mechanical stability of the aligner 100 in regions subject to force application. The shape of the geometric reinforcement can provide a differential of force application to the tooth The curved geometric reinforcements 106 are oriented to correspond with the natural curvature of the teeth and aligner 100, ensuring that the geometric reinforcement 106 integrates seamlessly within the structure.

Although FIGS. 2A and 2B illustrate an example model 200 for an integrated geometric reinforcement structure within a 3D software environment, various changes may be made to FIGS. 2A and 2B. For example, the number and placement of various components of the model 200 can vary as needed or desired. In addition, the model 200 may be used in any other suitable orthodontic manufacturing process and is not limited to the specific processes described above.

FIGS. 3A and 3B illustrate an example model 300 for an integrated geometric reinforcement 106 applied to a group of teeth in accordance with this disclosure. As shown in FIGS. 3A and 3B, a digital model 300 can be generated for an integrated geometric reinforcement 106 applied to a group of teeth within a 3D software environment. The geometric reinforcement 106 integrates with the aligner 100 in the model either as a continuation of the same type of geometry or as distinct components that contribute to the overall mechanical stability. The geometric reinforcements 106 can either function independently or be connected by a unifying structure that spans multiple teeth, reinforcing a particular zone or the entire contour of the aligner 100.

In FIG. 3A, the geometric reinforcement 106 are distributed across multiple teeth, following the natural curvature of the dental arch. These geometric reinforcements 106 are designed to resist flexing in response to applied forces, particularly in areas where biomechanical stress is concentrated. The placement of the geometric reinforcements 106 ensures that structural integrity is maintained throughout the aligner 100, preventing unwanted deformation that could compromise force application.

FIG. 3B shows a similar arrangement with a connector 302 that unites the geometric reinforcements 106 to provide structural reinforcement while maintaining flexibility. The design ensures that the aligner 100 retains its intended shape, preserving the effectiveness of force transmission to the teeth while minimizing undesired material deformation. The connector 302 can be made of a similar or different material than the geometric reinforcements 106. The connector 302 can be used to connect geometric reinforcements 106 corresponding to adjacent teeth. The connector 302 can be connected at one or more points on each of the geometric reinforcements. The connector 302 can be connected at an end of the geometric reinforcement 106 or between ends of the geometric reinforcement 106.wh

Although FIGS. 3A and 3B illustrate an example model 300 for an integrated geometric reinforcement 106 applied to a group of teeth, various changes may be made to FIGS. 3A and 3B. For example, the number and placement of various components of the model 300 can vary as needed or desired. In addition, the model 300 may be used in any other suitable orthodontic manufacturing process and is not limited to the specific processes described above.

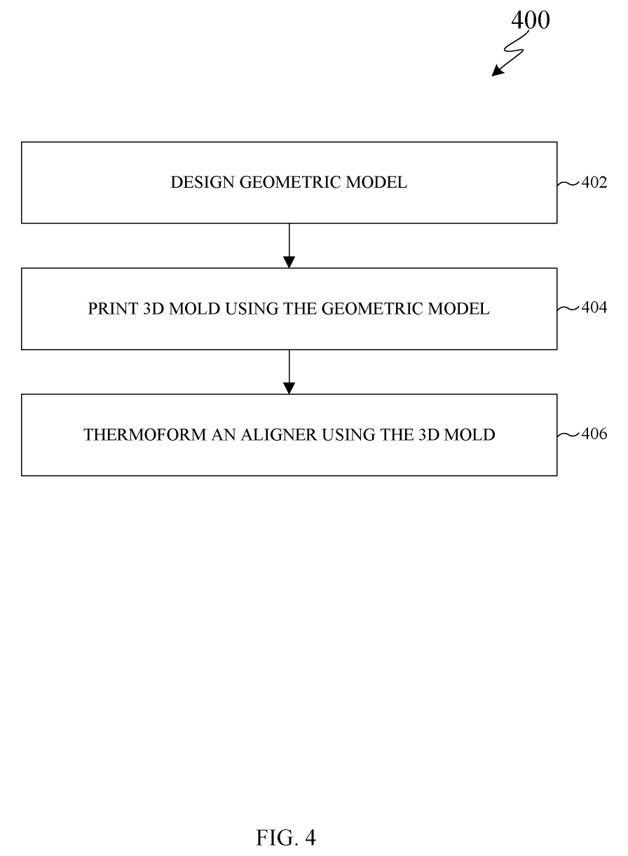

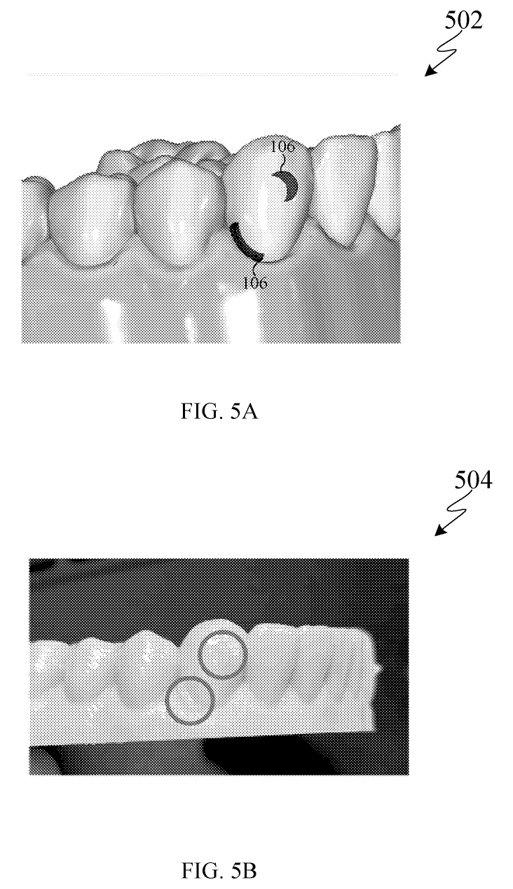

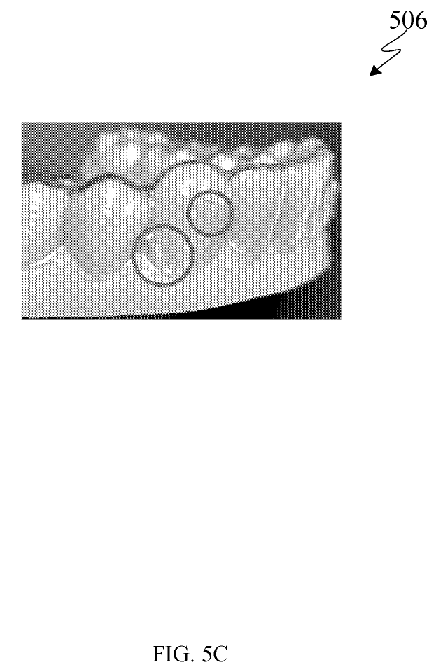

FIG. 4 illustrates an example process 400 for manufacturing clear aligner 100 having an integrated geometric reinforcement 106 in accordance with this disclosure. FIGS. 5A, 5B, and 5C illustrate example stages 502, 504, and 506 for manufacturing a clear aligner 100 having an integrated geometric reinforcement 106 in accordance with this disclosure. The FIGS. 5A, 5B, and 5C depict different stages of the design and fabrication process, showing the relationship between the geometric reinforcements 106 and the material of the aligner 100.

A geometric model can be designed in step 402. As shown in FIG. 4A, a digital model of a segment of the dental arch is designed. A geometric reinforcement 106 can be integrated into specific regions of the aligner 100 in the digital model. The geometric reinforcement 106 is positioned along the occlusal and lingual surfaces of selected teeth, following the contours of the aligner 100 to provide targeted structural support. The geometric reinforcement 106 is designed to be embedded within the material of the aligner 100 during fabrication, ensuring resistance to deformation while maintaining the overall shape of the aligner 100. The geometric model can be a digital model that includes a curved pathway along a gingival margin.

A 3D mold can be printed using the geometric model is step 404. FIG. 4B shows a physical model of the dental arch, used as a mold or model for thermoforming the aligner 100. The anatomical features of the teeth are well-defined, allowing the material of aligner 100 to conform precisely to the shape of the dentition. The geometric reinforcement 106 is visible in this stage, such that that the geometric reinforcement 106 is integrated into the aligner 100 during the thermoforming or direct printing process.

The aligner 100 is thermoformed using the 3D mold in step 406. FIG. 4C displays a completed clear aligner 100 fitted onto a dental model. The aligner 100 conforms to the contours of the teeth, with the geometric reinforcements 106 visibly integrated into the material. The geometric reinforcement 106 can have a shape that is curved and an orientation that corresponds to a natural curvature of a tooth. The shape of the geometric reinforcement can provide a differential of force application to the tooth. This allows the aligner 100 to apply different amount and directions of force to specific teeth, rather than moving all teeth equally at the same time. For example, the differential of force can be applied to a specific tooth in order to fix a rotation of the tooth, intrusion of the tooth, extrusion of the tooth, tipping of the tooth, bodily movement of the tooth, a root movement, or any other suitable movement of the tooth. These geometric reinforcements 106 are positioned in alignment with the digital design from FIG. 5A, ensuring that the final aligner 100 retains its intended structural characteristics. The interaction between the geometric reinforcements 106 and the material of the aligner 100 enhances mechanical stability while preserving the intended force application required for orthodontic treatment. Multiple geometric reinforcements can be used for a single tooth position and at least two of the multiple geometric reinforcements are curved and oriented to correspond to different natural curvatures of a tooth.

In certain embodiments, the aligner 100 can be printed from the geometric model. The aligner 100 conforms to the contours of the teeth, with the geometric reinforcements 106 visibly integrated into the material. The geometric reinforcement 106 can generate a differential force applied to a tooth that the main body 102 would not normally generate or increases the force that the main body 102 generates. The differential force is a force that is different from the regular force of the main body 102. These geometric reinforcements 106 are positioned in alignment with the digital design from FIG. 5A, ensuring that the final aligner 100 retains its intended structural characteristics. The interaction between the geometric reinforcements 106 and the material of the aligner 100 enhances mechanical stability while preserving the intended force application required for orthodontic treatment.

In certain embodiments, the main body 102 includes an extension 104 and the geometric reinforcement 106 can be integrated at least partially in the extension 104. In certain embodiments, the geometric reinforcement 106 can be integrated along the curved pathway of the gingival margin. In certain embodiments, multiple geometric reinforcements can be used in the aligner 100. Each of the multiple geometric reinforcements 106 can be integrated corresponding to a tooth in the digital model of the dental arch. The aligner 100 can also include a connector 302 configured to connect to adjacent geometric reinforcements of the multiple geometric reinforcements 106.

Although FIG. 4 illustrates an example process 400 for manufacturing clear aligner 100 having an integrated geometric reinforcement 106, various changes may be made to FIG. 4. For example, while shown as a series of steps, various steps in FIG. 4 may overlap, occur in parallel, or occur any number of times. Although FIGS. 5A, 5B, and 5C illustrate example stages 502, 504, and 506 for manufacturing clear aligner 100 having an integrated geometric reinforcement 106, various changes may be made to FIGS. 3A and 3B. For example, the stages 502, 504, and 506 may be used in any other suitable orthodontic manufacturing process and is not limited to the specific processes described above.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A clear aligner comprising:
a main body formed of a clear plastic and formed from a digital model of a dental arch; and
a geometric reinforcement integrated into the main body and configured to deflect or bend a portion of the main body to generate a differential force applied to a tooth.

2. The clear aligner of claim 1, wherein:
the main body includes an extension, and
the geometric reinforcement is integrated at least partially in the extension.

3. The clear aligner of claim 1, wherein:
the digital model includes a curved pathway along a gingival margin; and
the geometric reinforcement is integrated along the curved pathway.

4. The clear aligner of claim 3, wherein:
the geometric reinforcement includes multiple geometric reinforcements; and
each of the multiple geometric reinforcements is integrated corresponding to the tooth in the digital model of the dental arch.

5. The clear aligner of claim 4, further comprising:
a connector configured to connect to adjacent geometric reinforcements of the multiple geometric reinforcements.

6. The clear aligner of claim 1, wherein:
the geometric reinforcement has a shape that is curved and an orientation that corresponds to a natural curvature of the tooth, and
the shape of the geometric reinforcement is configured to provide the differential force to the tooth.

7. The clear aligner of claim 1, wherein:
the geometric reinforcement includes multiple geometric reinforcements; and
at least two of the multiple geometric reinforcements are curved and oriented to correspond to different natural curvatures of the tooth.

8. A method of manufacturing a clear aligner comprising:
designing a digital model of a dental arch;
printing a 3D mold using the digital model; and
thermoforming a main body formed of clear plastic with a geometric reinforcement integrated into the main body using the 3D mold, wherein the geometric reinforcement generates a differential force applied to a tooth.

9. The method of claim 8, wherein:
the main body includes an extension, and
the geometric reinforcement is integrated at least partially in the extension.

10. The method of claim 8, wherein:
the digital model includes a curved pathway along a gingival margin; and
the geometric reinforcement is integrated along the curved pathway.

11. The method of claim 10, wherein:
the geometric reinforcement includes multiple geometric reinforcements; and
each of the multiple geometric reinforcements is integrated corresponding to the tooth in the digital model of the dental arch.

12. The method of claim 11, further comprising:
a connector configured to connect to adjacent geometric reinforcements of the multiple geometric reinforcements.

13. The method of claim 8, wherein:
the geometric reinforcement has a shape that is curved and an orientation that corresponds to a natural curvature of the tooth, and
the shape of the geometric reinforcement is configured to provide the differential force to the tooth.

14. The method of claim 8, wherein:
the geometric reinforcement includes multiple geometric reinforcements; and
at least two of the multiple geometric reinforcements are curved and oriented to correspond to different natural curvatures of the tooth.

15. A method of manufacturing a clear aligner comprising:
designing a digital model of a dental arch; and
printing a main body formed of clear plastic with a geometric reinforcement integrated into the main body using the digital model, wherein the geometric reinforcement generates a differential force applied to a tooth.

16. The method of claim 15, wherein:
the main body includes an extension, and
the geometric reinforcement is integrated at least partially in the extension.

17. The method of claim 15, wherein:
the digital model includes a curved pathway along a gingival margin; and
the geometric reinforcement is integrated along the curved pathway.

18. The method of claim 17, wherein:
the geometric reinforcement includes multiple geometric reinforcements; and
each of the multiple geometric reinforcements is integrated corresponding to the tooth in the digital model of the dental arch.

19. The method of claim 18, further comprising:
a connector configured to connect to adjacent geometric reinforcements of the multiple geometric reinforcements.

20. The method of claim 15, wherein:
the geometric reinforcement has a shape that is curved and an orientation that corresponds to a natural curvature of the tooth, and
the shape of the geometric reinforcement is configured to provide the differential force to the tooth.
